(19) United States
(12) Patent Application Publication
(10) Pub. No.: US 2026/0189493 A1
(43) Pub. Date: Jul. 2, 2026

(54) METHOD, APPARATUS AND SYSTEM FOR TIME VARIANT ROUTING CONSISTENCY

(71) Applicant: Huawei Technologies Co., Ltd., Shenzhen (CN)

(72) Inventor: Peter James Ashwood-Smith, Gatineau (CA)

(21) Appl. No.: 19/546,087

(22) Filed: Feb. 20, 2026

Related U.S. Application Data
(63) Continuation of application No. PCT/CN2023/115735, filed on Aug. 30, 2023.

(51) Int. Cl. H04L 43/0888; H04L 43/0882; H04L 43/10

(52) U.S. Cl. CPC H04L 43/0888; H04L 43/0882; H04L 43/10

(57) ABSTRACT

Methods and apparatus for implementing time variant routing consistently at adjacent network nodes are provided. In an example method, a node can communicate with another node to obtain information indicative of whether scheduled communication link status changes are registered at the two nodes in an inconsistent manner. If so, one or both of the nodes adjust implementation of the scheduled changes to remove the inconsistency.

### CROSS-REFERENCE TO RELATED APPLICATION

The present application is a continuation of International Patent Application No. PCT/CN2023/115735, entitled “METHOD, APPARATUS AND SYSTEM FOR TIME VARIANT ROUTING CONSISTENCY,” filed on Aug. 30, 2023, the entirety of which is incorporated by reference herein.

### TECHNICAL FIELD

The present disclosure generally pertains to networking and communication and, in particular, to a method, apparatus and system for implementing time variant routing in communication networks.

### BACKGROUND

A new technology called Time Variant Routing (TVR) proposes to allow time-based, scheduled changes to a network. Time-based changes may include changes to links, adjacencies, traffic volumes, and cost.

In time variant routing, it is expected that a calendar (schedule) will be configured on nodes (e.g. routers) of the network, and that the nodes will be synchronized and follow link or attribute changes specified in the calendar at the appropriate times. Each node may require configuration as to when its link attributes are to be set in a specified manner. A centralized entity might thus be required to distributed related management configuration information to all nodes. Examples of attributes include a link being up or down, or a routing attribute such as link delay or link color being changed.

However, currently there is no provision to deal with incorrect or inconsistent configurations.

Therefore, improvements and developments in time variant routing protocols are desirable.

This background information is provided to reveal information believed by the applicant to be of possible relevance to the present application. No admission is necessarily intended, nor should be construed, that any of the preceding information constitutes prior art against the present application.

### SUMMARY

Embodiments of this disclosure provide for methods apparatuses and systems for maintaining consistency between network nodes (e.g. routers) implementing time variant routing (TVR). Once a at least one of a pair of proximate or adjacent network nodes (e.g. two nodes directly coupled via a link) receives TVR scheduling information, it communicates to provide, to the other node, its received scheduling information which is relevant to that link. If there is an inconsistency between the scheduling information at the two nodes, the inconsistency is addressed and resolved by at least one of the pair of nodes. The resolution may be performed by implementing one of a variety of rules. The particular rule to be applied may be selected depending on preconfiguration or other relevant information. Therefore, embodiments deal with inconsistent configurations that may arise due to errors or losses when performing TVR scheduling updates.

According to one aspect, there is provided a method performed by a node, such as a router, in a communication network. The method includes receiving, in association with a time variant routing scheme, information indicative of one or more scheduled changes in status of a communication link coupling the network node to a second network node. The one or more scheduled changes may be registered at the network node. The method includes communicating with the second network node to obtain information indicative of whether the one or more scheduled changes are registered at the second network node in an inconsistent manner. The inconsistent manner includes that the second network node has registered at least one of the scheduled changes to occur at a different respective time than those same schedule changes are registered to occur at the network node, or that the second network node has not registered at least one of the scheduled changes (which is registered at the network node), or that the second network node has registered an additional change which is not registered at the network node. The method includes, when the one or more scheduled changes are registered at the second network node in the inconsistent manner, adjusting implementation of the one or more scheduled changes such that the network node and the second network node operate consistently with respect to the status of the communication link.

In one possible implementation, adjusting implementation of the one or more scheduled changes includes ignoring a specified one of the scheduled changes (the second network node may also ignore or otherwise not implementing the specified one of the scheduled changes).

In one possible implementation, adjusting implementation of the one or more scheduled changes includes adjusting timing of a specified one of the scheduled changes to match with a corresponding timing of the specified one of the scheduled changes as to be implemented by the second network node.

In one possible implementation, the one or more scheduled changes includes a first change at a first time and a second change at a second time. The first time and the second time define endpoints of a first time interval. In such embodiments, the method further includes: adjusting the first time, the second time, or both, such that the first time, following adjustment, is a beginning of a new time interval, and the second time, following adjustment, is an end of the new time interval. The new time interval may be a union or an intersection of the first time interval and a second time interval. Further, the one or more scheduled changes as to be implemented by the second network node include the first change at a third time and the second change at a fourth time. The third time and the fourth time define endpoints of the second time interval.

In one possible implementation, the second network node also adjusts timing of the specified one of the scheduled changes as to be implemented by the second network node, or timing of another specified one of the scheduled changes as to be implemented by the second network node, or both. The timing of the one or more scheduled changes are made to match with the timing of the one or more scheduled changes as to be implemented by the second network node following the combined adjusting by the network node and the second network node.

In one possible implementation, adjusting the one or more scheduled changes includes scheduling the additional change at the network node.

In one possible implementation, the method further includes, prior to receiving the information indicative of the scheduled change: configuring the network node with one or more rules specifying how the network node is to adjust implementation of the one or more scheduled changes. Additionally or alternatively, the network may be configured with one or more rules specifying how to adjust implementation of the one or more scheduled changes.

In one possible implementation, communicating with the second network node or the other network node includes at least one of: sending a HELLO message indicative of the one or more scheduled changes as received by the network node; and receiving another HELLO message indicative of corresponding scheduled changes as registered at the second network node.

In one possible implementation, communicating with the second network node includes directly communicating with the second network node, e.g. via a single physical or virtual (tunneled) link.

According to another aspect of the present disclosure, there is provided another method, method performed by a node, such as a router, in a communication network. The method includes receiving, in association with a time variant routing scheme, information indicative of one or more scheduled changes in status of a communication link coupling the network node to a second network node. The scheduled changes may be registered at the network node. The method further includes communicating with the second network node to obtain information indicative of whether the one or more scheduled changes are registered at the second network node in an inconsistent manner. In contrast (or more generally to the above), the inconsistent manner includes that the second network node has registered at least one of the scheduled changes with a different configuration than at the network node, or that the second network node has not registered at least one of the scheduled changes (which is registered at the network node), or that the second network node has registered an additional change which is not registered at the network node. The method includes, when the one or more scheduled changes are registered at the second network node in the inconsistent manner, adjusting implementation of the one or more scheduled changes such that the network node and the second network node operate consistently with respect to the status of the communication link.

In one possible implementation, the different configuration includes that said at least one of the scheduled changes, as registered at the second network node, assigns a cost to the communication link, the cost being different from a corresponding cost assigned to the communication link at the network node.

In one possible implementation, the different configuration includes that said at least one of the scheduled changes, as registered at the second network node, assigns a link attribute to the communication link, the link attribute being different from a corresponding link attribute assigned to the communication link at the network node. The link attribute may be, for example, link color, link bandwidth or link delay.

In one possible implementation, the different configuration includes that the at least one of the scheduled changes, as registered at the second network node, assigns a traffic volume value to the communication link, the traffic volume value being different from a corresponding traffic volume value assigned to the communication link at the network node.

According to another aspect of the present disclosure, there is provided an apparatus, which may also be referred to as a network node. The apparatus may have a network interface and processing electronics. The apparatus may have at least one processor coupled with a memory. The memory stores instructions which, when executed by the at least one processor, cause the apparatus to operate as follows. The apparatus receives, in association with a time variant routing scheme, information indicative of one or more scheduled changes in status of a communication link coupling the apparatus to a second apparatus, referred to here as a second network node. The scheduled changes may be registered at the apparatus, for example in response (at least in part) to such receiving of information. The apparatus communicates with the second network node to obtain information indicative of whether the one or more scheduled changes are registered at the second network node in an inconsistent manner. The inconsistent manner includes that the second network node has registered at least one of the scheduled changes to occur at a different respective time than the at least one of the one or more scheduled changes is registered to occur at the apparatus, or that the second network node has not registered at least one of the scheduled changes which is registered at the apparatus, or that the second network node has registered an additional change which is not registered at the apparatus. When the one or more scheduled changes are registered at the second network node in the inconsistent manner, the apparatus adjusts implementation of the one or more scheduled changes such that the apparatus and the second network node operate consistently with respect to the status of the communication link. The apparatus may be a network node, or a component or module or chipsets of the network node.

According to another aspect of the present disclosure, there is provided an apparatus, which may also be referred to as a network node. The apparatus may have a network interface and processing electronics. The apparatus may have at least one processor coupled with a memory. The memory stores instructions which, when executed by the at least one processor, cause the apparatus to operate as follows. The apparatus receives, in association with a time variant routing scheme, information indicative of one or more scheduled changes in status of a communication link coupling the apparatus to another apparatus, referred to here as a second network node. The scheduled changes may be registered at the apparatus. The apparatus communicates with the second network node to obtain information indicative of whether the one or more scheduled changes are registered at the second network node in an inconsistent manner. In this case, the inconsistent manner includes that the second network node has registered at least one of the scheduled changes with a different configuration than at the apparatus, or that the second network node has not registered at least one of the scheduled changes which is registered at the apparatus, or that the second network node has registered an additional change which is not registered at the apparatus. The apparatus is configured, when the one or more scheduled changes are registered at the second network node in the inconsistent manner, to adjust implementation of the one or more scheduled changes such that the apparatus and the second network node operate consistently with respect to the status of the communication link. The apparatus may be a network node, or a component or module or chipsets of the network node.

Various other implementations and features of the above apparatuses can also be provided, commensurate with the corresponding methods as already described above.

In accordance with another aspect, there is provided an electronic apparatus (also referred to as an electronic device) in a communication network, the apparatus comprising processing electronics (e.g. at least one processor, and a memory storing computer program instructions, or at least one processor, coupled with a memory storing computer program instructions), the electronic device may further comprise a network interface. The electronic device is configured to perform one or more of the methods as described herein. The electronic apparatus may be a network node such as a router, for example. In accordance with embodiments, there is provided a system of such electronic apparatuses, networked together and configured to interact to perform one or more of the methods as described herein.

In accordance with another aspect of the present disclosure, there is provided a computer program product comprising a instructions stored thereon which, when executed by one or more computer processors, cause the computer processors to perform the method as set forth above. The computer processors may be parts of one or more electronic apparatuses (e.g. network entities or routers) as described herein. The computer program product may further comprise data or statements.

In accordance with another aspect of the present disclosure, there is provided a computer readable medium (e.g. non-transitory) computer readable medium storing instructions thereon which, when executed by one or more computer processors, cause the computer processors to perform the method as set forth above. The computer processors may be parts of one or more electronic apparatuses (e.g. network entities or routers) as described herein. The medium may further store data or statements.

In accordance with another aspect of the present disclosure, there is provided a communication system comprising an apparatus as set forth above, and a second node.

Aspects and implementations have been described above in conjunctions with aspects of the present application upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present application will become apparent from the following detailed description, taken in combination with the appended drawings, in which:

FIG. 1 illustrates an example time variant routing (TVR) scenario.

FIG. 2 illustrates an example of inconsistent TVR information held by two adjacent nodes.

FIG. 3 illustrates another example of inconsistent TVR information held by two adjacent nodes.

FIG. 4 illustrates operation of nodes to address TVR inconsistencies, according to an example of the present disclosure.

FIG. 5 illustrates operation of nodes to address TVR inconsistencies, according to another example of the present disclosure.

FIG. 6 illustrates different manners for adjusting implementation of a scheduled change as part of addressing a TVR inconsistency, according to an example of the present disclosure.

FIG. 7A illustrates an example of addressing a TVR inconsistency by taking an intersection of inconsistent time intervals at two nodes, according to an example of the present disclosure.

FIG. 7B illustrates an example of addressing a TVR inconsistency by taking a union of inconsistent time intervals at two nodes, according to an example of the present disclosure.

FIG. 7C illustrates another example of addressing a TVR inconsistency by taking an intersection of inconsistent time intervals at two nodes, according to an example of the present disclosure.

FIG. 7D illustrates another example of addressing a TVR inconsistency by taking a union of inconsistent time intervals at two nodes, according to an example of the present disclosure.

FIG. 8 illustrates an electronic device (e.g. router) which may be configured to perform operations according to example of the present disclosure.

It will be noted that throughout the appended drawings, like features are identified by like reference numerals.

### DETAILED DESCRIPTION OF THE ILLUSTRATIVE EMBODIMENTS

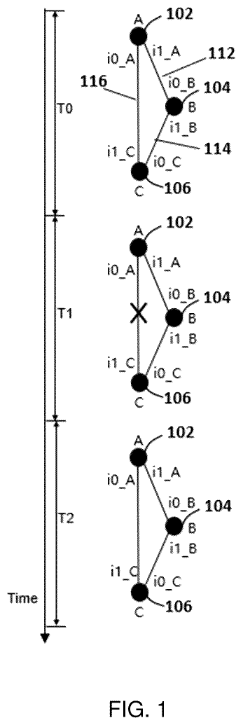

FIG. 1 illustrates an example TVR scenario involving three network nodes. Node A 102 is connected with two links which are locally named (by node A) as i0_A and i1_A; node B 104 is connected with two links which are locally named (by node B) as i0_B and i1_B; and node C 106 is connected with two links which are locally named (by node C) as i0_C and i1_C. Nodes A and B are directly connected to one another via the link 112 with local names i1_A and i0_B; nodes B and C are directly connected to one another via the link 114 with local names i1_B and i0_C; and nodes A and C are directly connected to one another via the link 116 with local names i0_A and i1_C. According to the TVR schedule, the link 116 between nodes A and C is usable (up) during time intervals T0 and T2, but unusable (down) during intervening time interval T1. Therefore, during time interval T1, node A and node C should route messages to one another via the link 116, i.e. via their respectively locally named links i1_A and i0_C, while at other times they can more effectively use links i0_A and i1_C, respectively, to route messages to one another via node B and the associated links 112 and 114. Thus, nodes A and C may adjust their routing tables in a time varying manner to reflect such a condition. During time interval T1, link 116, i.e. locally named links i0_A and i1_C are also considered to be down, while such links are considered to be up during time intervals T0 and T2.

Similar examples can be constructed for other link attribute changes. For example, again referring to FIG. 1, during time intervals T0 and T2 the link 116 may be assigned a first attribute value according to a schedule, while during time interval T1, the link 116 may be assigned a different attributed value according to the schedule.

However, currently there is no provision to deal with incorrect or inconsistent configurations. For example, if two adjacent nodes are scheduled to bring a link between them down at different times, there is an ambiguity or inconsistency. One node may consider the link down at a time when the other node considers the link to be up. As another example, if one of the two nodes is scheduled to change a link attribute so that it is at least temporarily different than the link attribute (for the same link) as held by the other of the two nodes (where the link attribute may be unchanged, for example), there is again an ambiguity or inconsistency. This can potentially cause network asymmetries, packet losses, routing irregularities, etc. To date this problem has not been addressed.

Therefore, improvements and developments in time variant routing protocols are desirable.

Provided are a method, apparatus and system in which network nodes address inconsistencies in TVR scheduling information, by exchanging potentially inconsistent scheduling information and adjusting their schedules to resolve inconsistencies, if present. This can involve individual actions of nodes including pairwise communication with other adjacent nodes in response to receiving potentially inconsistent scheduling information. An example of inconsistent scheduling information is that both nodes are scheduled to register a change (e.g. link state change from down to up) but the changes are scheduled to occur at different times. Another example is that one of the nodes is scheduled to register a change but the other is not. Nodes can communicate relevant scheduling information via messages such as router HELLO messages, which are augmented to include this information.

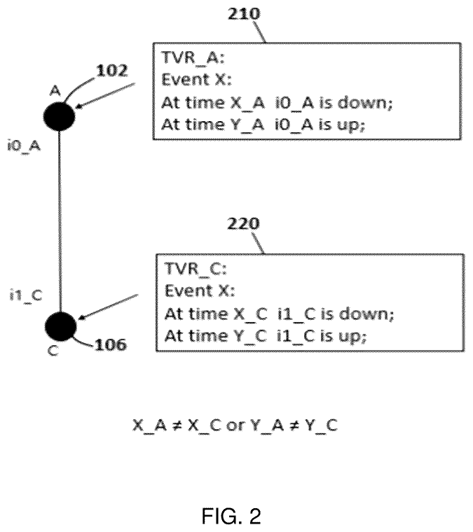

An illustrative example is described as follows, with reference to FIG. 2. In contrast to FIG. 1, only nodes A 102 and C 106 are shown for the sake of simplicity. Other nodes, such as node B, can be present to provide alternative routes as in FIG. 1. As in FIG. 1, node A directly communicates with node C via (locally named) link i0_A and node C directly communicates with node A via locally named link i1_C, when those links are available for use. These locally named links may refer to the same bidirectional link. TVR schedules 210, 230 are communicated (e.g. by a centralized entity) to nodes A and C. However, due to circumstances such as imperfect communication, message losses, errors, delays, timing issues, presence of multiple conflicting schedules, etc. the TVR schedule 210 communicated to node A (denoted TVR_A) is different from (i.e. inconsistent with) the TVR schedule 220 as determined by or as communicated to node C (denoted TVR_C), at least with respect to a given event, denoted Event X. For example, node A may have received an indication of a TVR schedule change whereas a corresponding indication of TVR schedule change to node C (e.g. the most recent such indication) may have been lost. In particular, according to TVR_A 210, link i0_A should be considered down during the time interval starting at time X_A and ending at time Y_A. At the same time, according to TVR_C 220, link i1_C should be considered down during the time interval starting at time X_C and ending at time Y_C, where X_A≠X_C, or Y_A ≠Y_C. Accordingly, nodes A and C have inconsistent TVR scheduling (or configuration) information. This can be problematic for example if node A attempts to use i0_A to communicate with node C when node C considers its corresponding link i1_C to be down.

For clarity, a link can be defined as a connection between two nodes (e.g. routers). Links can be, for example, physical fibers or wires or wireless connections, for example. The link state of a network (e.g. of routers) can refer to the state of all the links in the network. Common routing protocols will distribute link state information to all routers prior to computing tables that decide how packets are to be forwarded. A state of an individual link can refer to the state of that link, e.g. whether it is up (active) or down (inactive), the attributes and parameters specifying its operation and limitations, etc. Routing, as performed by a node such as a router, can involve the act of deciding where to forward a packet to get it to its ultimate destination. The decisions as to which links to include or exclude, for such routing purposes, may be based on the individual link's attributes and state.

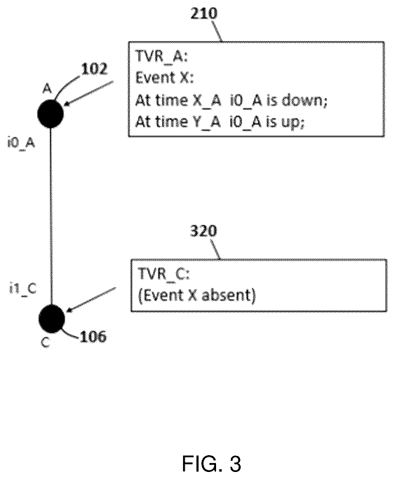

FIG. 3 illustrates another scenario in which an inconsistency is present. In this case, the inconsistency is that in TVR_A 210 for node A 102 the information for Event X is present and is the same as in FIG. 2, whereas in TVR_C 320 for node C 106 the information for Event X is absent. Similarly, the information for Event X may be absent in TVR_A but present in TVR_C. TVR_A and TVR_C can include other information not shown.

According to the present disclosure, the above issue is addressed as follows. It is noted that the TVR schedule is typically communicated in advance to the nodes. Therefore, the nodes have an opportunity to (and indeed do according to the present disclosure) communicate with one another to indicate, one to another, upcoming configuration changes. Once the configuration changes are communicated to a node, that node can operate to resolve inconsistencies, if present. Two nodes that are adjacent (e.g. communicatively coupled by a direct link) as in the case of nodes A and C will pass messages (e.g. router HELLO messages) in order to indicate relevant portions of their TVR schedules to one another. Inconsistencies, if present, can then be resolved by each node based on this information. In various examples, a direct link may be a tunnel, for example in the case of an overlay network or similar structure.

In some examples, when an inconsistency is present, the scheduled change (or event) associated with the inconsistency is rejected (ignored) at both nodes. This can be done for each inconsistency. The scheduled change is indicated in at least one of the TVR schedules of the two nodes. The scheduled change can be, for example, that the link between the two nodes (and the corresponding interfaces at the two nodes) is to be considered to change from up (in-service state) to down (outage state) at a specified time. In this case, by rejecting the scheduled change, the two nodes continue to consider the link between them to be up. In this manner, the inconsistency is resolved by ignoring the scheduled change exhibiting an inconsistency. In some examples, instead of ignoring a scheduled change or changes, an event which includes the scheduled change or changes can be ignored. The event can include a first change (e.g. link changes from up to down at a start time) and a second change (e.g. link changes from down to up at an end time).

In some examples, when an inconsistency is present, the scheduled change (or event) associated with the inconsistency is implemented (adopted) by the two nodes in a modified manner, such that the inconsistency is removed or at least mitigated. This can be done for example by adjusting the timing of the scheduled change, as it is implemented by the two nodes, such that both nodes implement the change at the same time. Such adjustment can be performed in a variety of ways. In some examples, the nodes may generally communicate to agree on an implementation which is consistent at both nodes. In some examples, one or both of the nodes may independently adjust the scheduled change in a manner that removes the inconsistency. In some examples, instead of removing inconsistencies for a scheduled change or changes, the inconsistencies of an entire event can be removed. As before, the event can include a first change (e.g. link changes from up to down at a start time) and a second change (e.g. link changes from down to up at an end time).

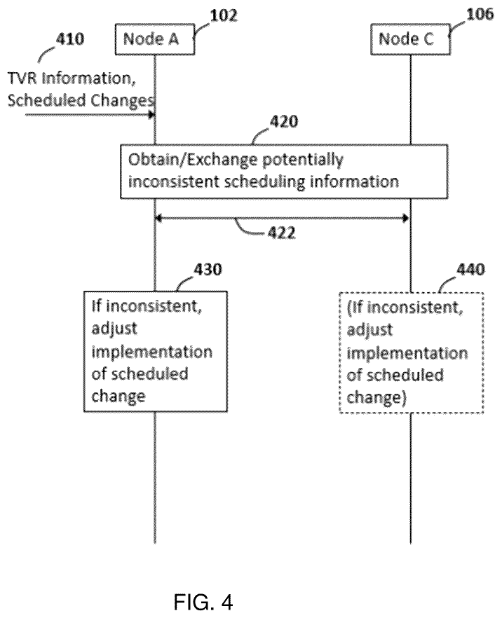

FIG. 4 illustrates operation of network node A 102 (e.g. a router) to resolve an inconsistency. At 410 node A 102 receives information indicative of one or more scheduled changes to a communication link status. The communication link couples the node A with node C 106 (e.g. as link 116 in FIG. 1). The information may be received in association with a TVR scheme, e.g. as an update from a TVR scheduler. At 420 node A 102 operates to obtain potentially inconsistent scheduling information. Inconsistency is between node A's scheduling information and corresponding scheduling information held by an adjacent node, node C 106 which uses the link to communicate to, from, or both to and from node A. This involves communicating 422 (unidirectionally or bidirectionally) with node C to obtain node C's relevant scheduling information, and potentially also to provide node C with node A's relevant scheduling information. Scheduling information of the two nodes may be consistent or inconsistent in that the one or more scheduled changes are registered at the second network node in a consistent or inconsistent manner, respectively, for example as described below.

The inconsistent manner can include, for example, that node C 106 has registered at least one of the scheduled changes to occur at a different respective time than node A 102. For example, the two nodes may have received different versions of the information, or one of the versions may have been lost or corrupted. The inconsistent manner can include, for example, that node C has not registered at least one of the scheduled changes which is registered at node A. For example, node C may not have received an update, or it may have received an additional update cancelling a change, or the two nodes may have received different versions of the information, or one of the versions may have been lost or corrupted. The inconsistent manner can include, for example, that node C has registered an additional change which is not registered at node A. This may occur for similar reasons to those above.

Other inconsistent manners may also occur. Generally, the inconsistent manner may include that node C 106 has registered at least one of the scheduled changes (e.g. as part of a corresponding event) with a different configuration than at node A 102, or otherwise (as above), that node C has not registered at least one of the scheduled changes which is registered at node A, or else that node C has registered an additional change which is not registered at node A. A different configuration can include a different timing as already described above.

A different configuration can include that one of the scheduled changes, as registered with node C 106, assigns a first link attribute value to the communication link, whereas node A 102 assigns a second, different link attribute value to the communication link. There are a variety of link attributes that can be assigned and used for different purposes, such as routing, and that can vary over time according to TVR. An example of an attribute is bandwidth. Another example of an attribute is link color. Yet another example of an attribute is link delay. A link color assigns a particular attribute such as A, B, C or Red, Green, Yellow to a link, this attribute being potentially held in common with other links. Each set of links of the same color can be treated as a sub-graph or sub-network of an overall network comprising links of all colors. The link colors can then be used for routing purposes. For example, packets may be routed, where possible, in a multi-hop manner only via a plurality of links of a same given color. As another example, links which require a relatively large amount of power (or other cost) may be colored red while links which require a relatively small amount of power (or other cost) may be colored green. Routes may then be configured to use only green links at certain times, while at other times red links may also be allowed.

A different configuration can include that one of the scheduled changes, as registered with node C 106, assigns a first cost to the communication link, whereas node A 102 assigns a second, different cost to the communication link at the time of the scheduled change. Link costs can be assigned and used for routing purposes, and may reflect real costs (e.g. energy, time, charges, bandwidth, etc.) or arbitrary costs, or a combination thereof, as will be readily understood by a worker skilled in the art. Link cost can also be regarded as a link attribute.

A different configuration can include that one of the scheduled changes, as registered with node C 106, assigns a first traffic volume to the communication link, whereas node A 102 assigns a second, different traffic volume to the communication link at the time of the scheduled change. Traffic volumes can be assigned and used for routing purposes, and may reflect the (e.g. average or maximum) amount of traffic that is to traverse a link. Traffic volumes can also be regarded as a link attribute.

When there is no inconsistency, the two nodes may adopt the schedules and treat the link between them differently at different times according to the schedule, which is the same at both nodes, and which requires no adjustment at either node.

On the other hand, when the one or more scheduled changes are registered at nodes A and C in an inconsistent manner, one or both of the nodes 102, 106 may adjust 430, 440 implementation of the one or more scheduled changes, in such a manner that the inconsistency is resolved. That is, the adjustment is such that nodes A and C network node operate consistently with respect to the status of the communication link. For purposes of illustration, it can be assumed that at least node A performs such an adjustment, i.e. adjustment 430. Node C may operate in a similar manner to node A and can also perform a corresponding adjustment 440. Alternatively, only one of nodes A and C might perform an adjustment, in such a manner that just this one node's adjustment resolves the inconsistency.

In various examples, each node operates independently to resolve inconsistencies, if present. That is, after the obtaining of information in operation 420, the nodes no longer communicate to facilitate such resolution. In this case, the rules of operation at the nodes are coordinated in advance so that resolution of the inconsistencies will result. In other examples, the nodes may communicate with one another for example to negotiate how the inconsistencies are to be resolved.

In some examples, a node may make an explicit determination as to whether an inconsistency is present. If such a determination is made, the node may operate to resolve the inconsistency. Otherwise, the node may take no further action. For example, node A can compare the scheduling information for the two nodes to determine whether the schedules are consistent or inconsistent. If there is an inconsistency, the subsequent adjustment can be performed.

In some examples, a node does not make an explicit determination as to whether an inconsistency is present. Rather, the node may process its own scheduling information together with the scheduling information received from another node in a manner that results in an adjustment when the two scheduling informations are inconsistent, and that results in no adjustment otherwise. For example, node A can receive the scheduling information from node C and process this information together with its own scheduling information without explicitly checking for inconsistency. The outcome of the processing can then be taken as the adjusted schedule for node A.

As an example, suppose node A implements a processing rule that takes two timings: the timing of a change scheduled at node A and the (potentially different) timing of the same change scheduled at node C, and outputs an adjusted timing of the change for use at node A. The adjusted timing can be, for example, the maximum of the two timings, the minimum of the two timings, the average of the two timings, etc. Now, if the two timings are the same, then the adjusted timing is the same as the original timing for the change at node A. But, if the two timings are different, then the adjusted timing is different. The adjustment rule can thus be characterized by a scalar-valued mathematical function f(x,y) with the property that f(x,x)=x. As well, it may be required that f(x,y)=f(y,x) (i.e. the function is symmetric). The inputs of the function are the timings of the change initially scheduled at nodes A and C, and the output of the function is the adjusted timing of the change at node A. Node C can operate in the same manner.

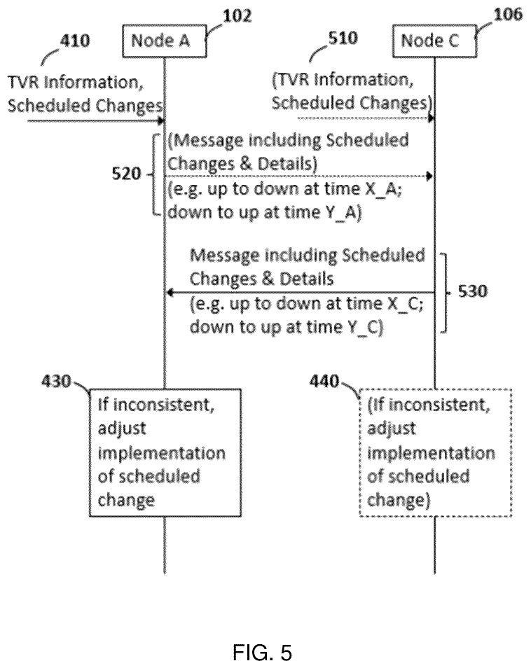

FIG. 5 illustrates an example similar to FIG. 4, but with more detail. As illustrated, node C may also receive, at 510 information indicative of one or more scheduled changes to a communication link status. This information may be different than that information received by node A, in which case an inconsistency may be present for resolution. The information 410 may be received at a same time, substantially a same time, or at a different time than the information 510. Node A then sends a message 520 to node C, including its own information about scheduled changes (if any) to the link 116 between nodes A and C, as well as any applicable details. For example, the message 520 from node A to node C may indicate that the link is to transition from an up state to a down (outage) state at time X_A, and to transition from the down state to the up state at time Y_A. Node C also sends a message 530 to node A, similarly including its own information about scheduled changes (if any) to the (same) link between nodes A and C, as well as any applicable details. For example, the message 530 from node C to node A may indicate that the link is to transition from an up state to a down (outage) state at time X_C, and to transition from the down state to the up state at time Y_C. Two messages 520 and 530 are shown for symmetry, although in some cases one of the messages (e.g. message 520) may be omitted. In such a case, only the node receiving a message (e.g. node A) might check for inconsistencies and adjust implementation of scheduled changes to resolve such inconsistencies, if any. Node A then performs the operation 430 of adjusting implementation of scheduled changes, as already described above. Similarly, Node C may also perform the operation 440 of adjusting implementation of scheduled changes.

As illustrated in FIGS. 4 and 5, nodes A and C communicate with one another to exchange information indicative of potential inconsistencies. The communication may involve messaging, such as router HELLO messages. The messaging may be direct between the two nodes A and C. Alternatively, the messaging may be indirect, e.g. relayed via another node.

The adjustments at each node may be performed with or without further communication between the nodes. For example, each node may perform adjustments in a predictable manner, such that even when each node performs the adjustments independently, the inconsistency is resolved. For example, if an inconsistent change is ignored at both nodes, then the inconsistency is resolved. As another example, if predetermined rules are followed such that only one of the two nodes adjusts implementation of an event so that it is the same as the other node, then the inconsistency can be resolved. Alternatively, the nodes may communicate or negotiate further to resolve the inconsistency.

In some examples, the operations to perform an adjustment may be performed, but such adjustment may result in no actual change. In this case, the adjustment can be considered to either be performed or omitted.

In some examples, the operations to perform an adjustment may be performed unconditionally, with the operations resulting in a change if there is an inconsistency, or resulting in no change if there is no inconsistency.

The one or more scheduled changes may include a first change at a first time (e.g. start time) and a second change at a second time (e.g. end time), according to an event which begins at the first time and ends at the second time. Such an event may correspond to a temporary link outage or temporary link configuration change.

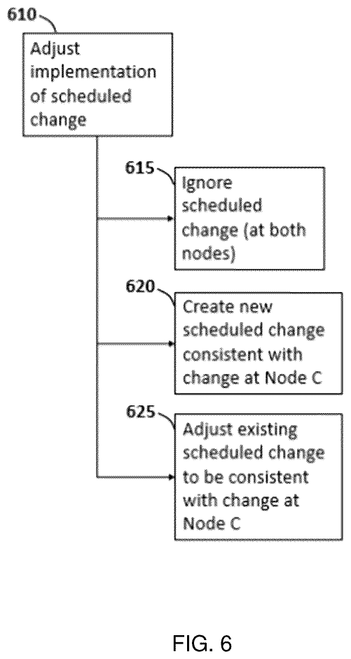

FIG. 6 illustrates adjusting implementation of a scheduled change 610 by node A, according to various examples. It is assumed that the change is scheduled at node A but is inconsistent with the schedule of node C. Node C can perform adjustments similarly, if required. The adjustment can be performed according to predetermined, negotiated or communicated rules between the two nodes. In some examples, the rules can be specified via OAM commands, e.g. from a central device such as the device which issues TVR scheduling information. The rules may specify which of the following actions are taken. The rules may specify how implementations of scheduled changes are to be adjusted. Nodes can be preconfigured with such rules so that they operate in a consistent manner and the adjustments, once performed, result in the resolutions of schedule inconsistencies.

In some examples, node A ignores 615 the scheduled change, with the understanding that node C will also ignore (or otherwise is not implementing) the scheduled change. This may be applicable if both nodes have registered the scheduled change but inconsistently (e.g. with inconsistent timing or other attribute), or if one of the nodes (e.g. node A) has registered the scheduled change but the other (e.g. node C) has not.

In some examples, node A creates 620 a new scheduled change which is consistent with a scheduled change already registered at node C. For example, the new scheduled change may be created so that it has consistent timing (or other attributes) with the change as it is already registered at node C. As another example, the scheduled change may be created so that it has consistent timing (or other attributes) with the change as registered at node C, after node C has also performed some predictable adjustment to the change. This scenario may be applicable if node C has registered the scheduled change but node A has not.

In some examples, node A adjusts 625 an existing scheduled change so that it is consistent with a corresponding scheduled change registered at node C. This may be applicable if both nodes A and C have registered the scheduled change, but with some inconsistency, e.g. in terms of timing, attributes, etc. The adjustment may be performed according to certain rules, so that it results in the inconsistency being resolved. The adjustment may include adjusting timing of the scheduled change to match with timing of the same scheduled change as it is to be implemented by node C. This may include cases where node C does not make any adjustments to the scheduled change, and cases where node C is expected to perform some predictable adjustment to the scheduled change.

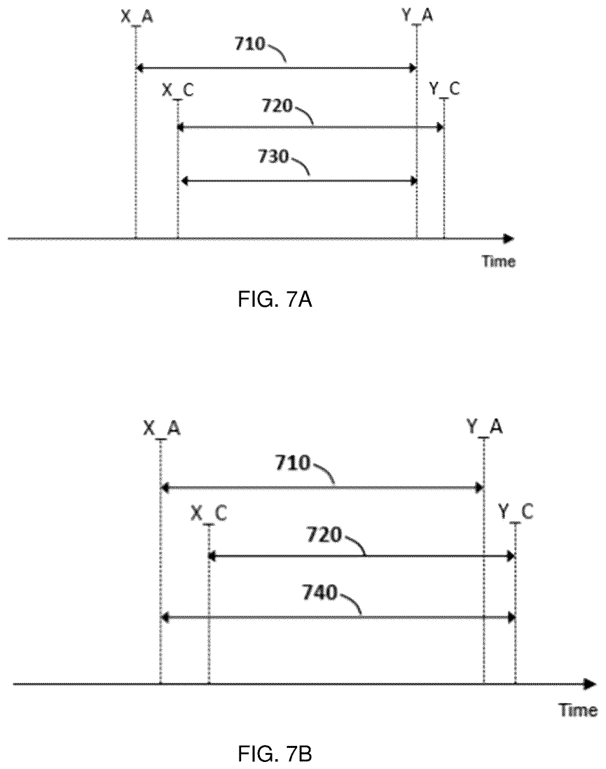

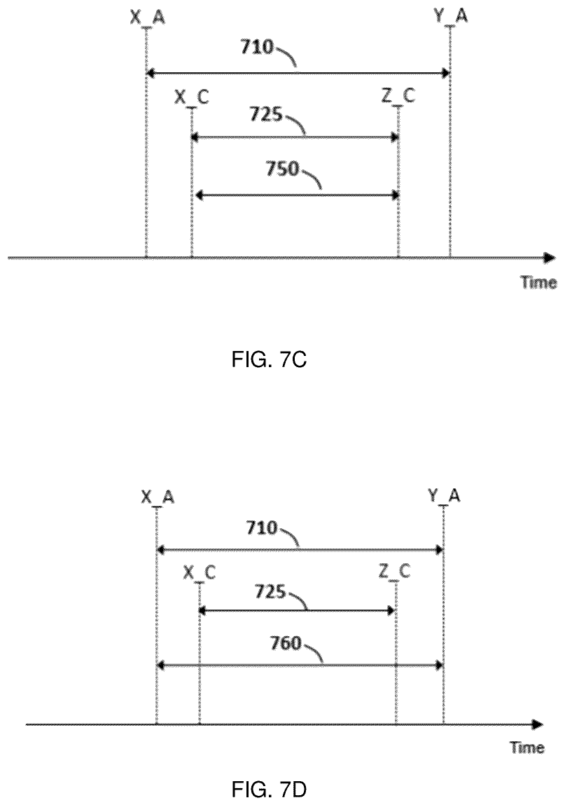

FIG. 7A illustrates an example embodiment in which two scheduled changes, corresponding to an event, are adjusted at two nodes A and C, in a particular manner which corresponds to taking an intersection of two time intervals. The two time intervals are a first time interval 710 of the event as registered by node A and a second time interval 720 of the event as registered by node C. In more detail, as registered by node A, there is a first change at a first time X_A and a second change at a second time Y_A. The first time and the second time define endpoints of the first time interval 710. The first time and the second time represent endpoints of an event, such as a link outage event, or temporary link attribute adjustment event, as registered to node A. As registered by node C, there is also the first change at a third time X_C and the second change at a fourth time Y_C. The third time and the fourth time define endpoints of the second time interval 720. The third time and the fourth time represent endpoints of the event, as registered to node C. Also illustrated is a new time interval 730 which is an intersection of the first time interval 710 and the second time interval 720. In this example, the new time interval begins at the third time X_C and ends at the second time Y_A.

In the present example, adjusting timing of the at least one of the scheduled changes at node A can include the following operations. The first time, the second time, or both, are adjusted, such that the first time, following adjustment, is a beginning of the new time interval 730 and the second time, following adjustment, is an end of the new time interval 730. In the present example, at node A, the first time is adjusted (changed) from X_A to X_C. The second time Y_A is not adjusted in this example but might be under other circumstances (see FIG. 7C). Another way to express the intersection operation is that the new time interval begins at a time which is a maximum of the two beginning times X_A and X_C, and ends at a time which is a minimum of the two end times Y_A and Y_C.

It is noted that node C can perform the same type of adjustment as node A (adjusting its time interval to be an intersection of two time intervals), independently of node A. If both nodes perform such an adjustment, the result is that the endpoints are aligned and the changes are made in a consistent manner. In the present case, node A changes the time of the first change from X_A to X_C, while node C changes the time of the second change from Y_C to Y_A. In the examples of FIGS. 7B to 7D and in other cases, node C can similarly perform the same type of adjustment as node A, if required. In FIG. 7C, no adjustment is required by node C. That is, node C can also adjust timing of scheduled changes as to be implemented by node C. Following the combined adjusting of timings by nodes A and C, the timing of all scheduled changes at issue match with one another.

FIG. 7B illustrates an example embodiment in which two scheduled changes, corresponding to an event, are adjusted at two nodes A and C, in a particular manner which corresponds to taking a union of two time intervals. The two time intervals are, again, the first time interval 710 of the event as registered by node A and the second time interval 720 of the event as registered by node C, as already described above. Also illustrated is a new time interval 740 which is a union of the first time interval 710 and the second time interval 720. In this example, the new time interval begins at the third time X_A and ends at the second time Y_C.

In the present example, adjusting timing of the at least one of the scheduled changes at node A can include the following operations. The first time, the second time, or both, are adjusted, such that the first time, following adjustment, is a beginning of the new time interval 740 and the second time, following adjustment, is an end of the new time interval 740. In the present example, at node A, the first time is not adjusted, but might be adjusted under other circumstances. The second time is adjusted (changed) from Y_A to Y_C. Another way to express the union operation is that the new time interval begins at a time which is a minimum of the two beginning times X_A and X_C, and ends at a time which is a maximum of the two end times Y_A and Y_C.

FIG. 7C illustrates another example embodiment in which two scheduled changes, corresponding to an event, are adjusted at two nodes A and C, in a particular manner which corresponds to taking an intersection of two time intervals. The first time interval 710 is the same as in FIGS. 7A and 7B. The second time interval 725 is different from new time interval 720 in that, instead of the second time interval 725 ending at a fourth time Y_C which is later than Y_A, the second time interval 725 ends at a different fourth time Z_C which is earlier than Y_A. In this case, as shown, the new time interval 750, which is an intersection of the first time interval 710 and the second time interval 725, is the same as the second time interval 725. As such, node C does not need to make any adjustments. However, node A makes two adjustments. In particular, the first time is adjusted (changed) from X_A to X_C, and the second time is adjusted from Y_A to Z_C. Thus, the new time interval (for both nodes) again begins at a time X_C which is the maximum of the two beginning times X_A and X_C, and ends at a time Z_C which is a minimum of the two end times Y_A and Z_C.

FIG. 7D illustrates another example embodiment in which two scheduled changes, corresponding to an event, are adjusted at two nodes A and C, in a particular manner which corresponds to taking a union of two time intervals. The first time interval 710 is the same as in FIGS. 7A to 7C and the second time interval 725 is the same as in FIG. 7C. In this case, as shown, the new time interval 760, which is a union of the first time interval 710 and the second time interval 725, is the same as the first time interval 710. As such, node A does not need to make any adjustments. However, node C makes two adjustments. In particular, at node C, the first time is adjusted (changed) from X_C to X_A, and the second time is adjusted from Z_C to Y_A. Thus, the new time interval (for both nodes) begins at a time X_A which is the minimum of the two beginning times X_A and X_C, and ends at a time Y_A which is a maximum of the two end times Y_A and Z_C.

It is noted that, when the rules for taking unions or intersections are followed, e.g. by taking a maximum or minimum of two values, a node can follow certain unconditional rules which inherently result in an adjustment being made or not, as necessary. For example, in FIG. 7D, node A can compute the new time interval by setting the interval start time to begin at the minimum of times X_A and X_C, and setting the interval end time to end at the maximum of times Y_A and Z_C. This will result in no changes to the time interval, but the computation can nonetheless be carried out. Both nodes can implement the same rule (e.g. to take a union or intersection of two time intervals) independently so that the same time interval results at both nodes. More generally, both nodes can implement rules which result in the inconsistency being resolved because both nodes make the same changes at the same times.

According to examples, the two nodes exchange future time based configuration changes over the link affected by a future change as indicated in information such as TVR scheduling information. This process can be performed by some or all pairs of nodes connected to one another via a link. The nodes may either reject the changes or adjust the time based configuration changes when those changes are inconsistent at both ends of the link affected by the configuration change. The nodes may both use a consistent rule to resolve the inconsistency (conflict) such that both nodes adopt the same adjusted configuration at the same time. Node configuration may include information about rules to apply in the event of inconsistent (conflicting) configuration information.

Examples of rules that can be applied to resolve timing inconsistencies include, as set forth above, taking a union of two time intervals or taking an intersection of two time intervals. Other rules can also be used. The rules may apply to time intervals (e.g. having a beginning or an end), or two individual time points (e.g. the time of a change in link status regardless of whether it is the beginning or end of an interval. For example, given two times, a rule may be adopted at each node which takes an average of the two times, in order to resolve the inconsistency. The average may be weighted or unweighted, according to configuration information. Other interpolations or adjustments may be performed according to agreed-upon rules, which may be described using mathematical functions, logic statements, computer program code, etc. As another example, given two times, the timing at one node may be taken to be correct, and the other node may adjust its timing to match this. The node taken to have the correct timing can be selected arbitrarily, randomly, or according to a predetermined rule, such that both nodes make the same selection.

More generally, given two times, or given two inconsistent attributes, a function, which is applied consistently at both nodes, may be implemented to return a single time or a single attribute. Alternatively, given one, two or more first attributes for an event (e.g. beginning and end times) for one node, and one, two or more second attributes for the event (e.g. beginning and end times) for another node, a function, which is applied consistently at both nodes, may be implemented to return one, two or more first attributes for the event, to be applied at both nodes. Thus, inconsistencies can be resolved individually or collectively.

Embodiments may be applied to network nodes such as a pair of routers. The nodes may be a subset of a significantly larger set of nodes. Each node, or at least some of the nodes may be configured as described herein. In some examples, the nodes are moving as would be the case for nodes integrated into Low Earth Orbit (LEO) satellites or High Altitude platforms (HAPS).

According to examples, it has been determined (e.g. by a central scheduler) that at some time T the link between two nodes is to be down or inactive. This may be for example due to the link being unusable due to an upcoming obstruction (e.g. in the case of mobile nodes which are obstructed from line-of-sight communication) or simply because there is sufficient capacity elsewhere to handle the expected traffic and powering off the link will save power. The rules may be configured to reflect the cause of inactivity. For example, if a link is unusable, a change should not be rejected to resolve an inconsistency.

In an example scenario, an operations and management command (OAM) is issued to both nodes indicating that the link between them should be brought down at time T and back up at time T+dt. When the operations commands are correct and properly synchronized to both nodes there is no issue. However when the command reaches node A before node C, or has different content at nodes A and C as may often happen in real operations, there is an inconsistency (ambiguity) as to what nodes A and C should do. It is desirable that even under such inconsistency, both nodes A and C agree on the time the link should be taken down and for how long. According to examples, nodes A and C exchange, via communication with one another, the details of their operations commands, such as times T and T+dt. Based on this information, the nodes each compute a deterministic actual time and duration bring the link down. This may be done for example by taking the intersection between the two time intervals, or by taking the union between the two time intervals.

Embodiments of the present disclosure apply to routers running OSPF or ISIS or other layer 3 or layer 2 routing/forwarding protocol (BGP etc.) that maintains a link between the two routers. Such routers may be augmented to have OAM commands that tell the routers when the links should be brought down and up. The routers may be in Satellites, HAPS, data centers or other locations where either obstructions require periodic shutdown of links, or where the ebb and flow of traffic demands is predictable and shutdown of physical links (and related hardware) will have a beneficial effect on the power usage of the routers without having a detrimental effect on the quality of traffic flow in the network.

According to examples, nodes can exchange information with one another via HELLO messages, such as OSPF, ISIS, BGP or other HELLO messages. A hello message can be a packet sent from a node such as a router, to establish and confirm network adjacency relationships or other information.

When a node receives scheduling information, such as an operational command indicating a time in the future to bring one of its adjacent links down and a time in the future when that link should be brought back up, the node may add this information to its normal HELLO adjacency exchange protocol for the affected link. In this manner the node at the other side of the affected link will receive the information about when the link may be brought down and back up by its peer. Information such as link attributes, timing, etc. can be exchanged in this manner, so that the two nodes can resolve inconsistencies.

The peer node at the other end of the link may perform a similar operation to inform the node of its own scheduling information (e.g. indicating the times it intends to bring the link down and up). In this manner nodes at both ends of the affected link are informed of each others'information.

Both nodes can then use the information provided by the other, along with their own information, to resolve a scheduling inconsistency, if present. The inconsistency may be characterized for example by link outage start times being different or link outage end times being different, or both.

If both sides agree and implement a scheduled change in a consistent manner, then the link may be safely brought down at the agreed to time and back up at the agreed to time. If however there is an inconsistency (disagreement), then the nodes can operate to resolve this. There are several solutions that can be employed so that both sides implement the scheduled changes consistently, e.g. by synchronously behaving in a same or complementary manner.

One solution is for both nodes to do nothing, and thus ignore the scheduled change. The link status will not change (e.g. will not go down) at the scheduled time because of the inconsistency. If and when the inconsistency is subsequently resolved by new OAM commands, the link change can occur.

When the inconsistency relates to the timing of an event (e.g. beginning times, ending times, or both), another solution is for both nodes to compute the intersection of two inconsistent time intervals defining the beginning and ending of the event. Each of the two time intervals is held by a different one of the nodes. The event may be a temporary link outage. This means that the actual time that the event begins will be the later of the two time interval beginnings, and the actual time that the event ends will be the earlier of the two time interval endings. Each node can calculate these times independently and perform the prescribed actions (e.g. consider link to be down, followed by considering link to be up) at the times resulting from the calculations. If the intersection is empty, i.e. there is no overlap between the two time intervals, then there will be no scheduled event and the nodes take no action.

A similar solution, when the inconsistency relates to the timing of an event, is for both nodes to compute the union of the two inconsistent time intervals defining the beginning and ending of the event. This means that the actual time that the event begins will be the earlier of the two time interval beginnings, and the actual time that the event ends will be the later of the two time interval endings. Again, each node can calculate times independently and perform the prescribed actions at the resulting times.

A notable feature is that peer nodes exchange with one another schedules of changes such as beginnings and endings of link up/down events on links. Peer nodes can detect consistency or inconsistency of changes or events based on the exchanged information, and can make adjustments to resolve such inconsistencies.

In various examples, when an inconsistency is present at a node, the node may report the inconsistency, or register the inconsistency for later reporting. The report may take the form of an alert or alarm, for example, made to a scheduler. The scheduler may address the inconsistency upon receiving the report.

It is noted that examples of the present disclosure can be implemented in a variety of networks or situations. For example a Data Center link may be monitored by AI to determine a pattern to its usage and that pattern can lead to generation of OAM commands to bring down the link at times of low/no usage. In this case an inconsistency can be dealt with by the routers themselves without having to rely on global consistency from the AI or OAM system.

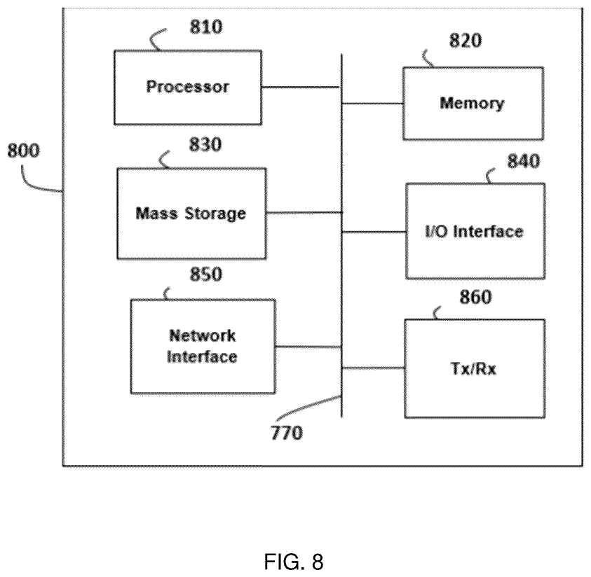

FIG. 8 is a schematic diagram of an electronic device 800 (e.g. a router) that may perform any or all of operations of the above methods and features explicitly or implicitly described herein, according to different embodiments of the present disclosure. For example, a computer equipped with network function may be configured as an electronic device 800. As another example, a router, switch or other device equipped with processing electronics may be configured as the electronic device 800.

As shown, the electronic device includes a processor 810, such as a Central Processing Unit (CPU) or specialized processors such as a Graphics Processing Unit (GPU) or other such processor unit, memory 820, non-transitory mass storage 830, I/O interface 840, network interface 850, and a transceiver 860, all of which are communicatively coupled via bi-directional bus 770. According to certain examples, any or all of the depicted elements may be utilized, or only a subset of the elements. Further, the device 800 may contain multiple instances of certain elements, such as multiple processors, memories, or transceivers. Also, elements of the hardware device may be directly coupled to other elements without the bi-directional bus. Additionally or alternatively to a processor and memory, other processing electronics, such as integrated circuits, analog circuitry, digital circuitry, or a combination thereof, may be employed for performing the required logical operations.

The memory 820 may include any type of non‘-transitory memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain examples, the memory 820 or mass storage 830 may have recorded thereon statements and instructions executable by the processor 810 for performing any of the aforementioned method operations described above.

It will be appreciated that, although specific examples of the technology have been described herein for purposes of illustration, various modifications may be made without departing from the scope of the technology. The specification and drawings are, accordingly, to be regarded simply as an illustration of embodiments of the present application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding examples, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the examples of the present application. For example, such an execution may correspond to a simulation of the logical operations as described herein. The software product may additionally or alternatively include a number of instructions that enable a computer device to execute operations for configuring or programming a digital logic apparatus in accordance with examples of the present application.

A combination of features in the illustrated examples could be performed, and when combining them, not all of them need to be combined to realize the benefits of various examples of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

Although the present application has been described with reference to specific features and embodiments thereof, it is evident that various modifications and combinations can be made thereto without departing from the application. The specification and drawings are, accordingly, to be regarded simply as an illustration of the application as defined by the appended claims, and are contemplated to cover any and all modifications, variations, combinations or equivalents that fall within the scope of the present application.

Embodiments have been described above in conjunctions with aspects of the present application upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

What is claimed is:

1. A method, comprising:
receiving, by a first network node in association with a time variant routing scheme, information indicative of one or more scheduled changes in status of a communication link coupling the first network node to a second network node, the one or more scheduled changes being registered at the first network node;
communicating, by the first network node, with the second network node to obtain information indicative of whether the one or more scheduled changes are registered at the second network node in an inconsistent manner, wherein the inconsistent manner comprises at least one of: the second network node having registered at least one of the one or more scheduled changes to occur at a different time than a corresponding one of the one or more scheduled changes is registered to occur at the first network node, the second network node having not registered at least one of the one or more scheduled changes, or the second network node having registered an additional change which is not registered at the first network node; and
when the one or more scheduled changes are registered at the second network node in the inconsistent manner, adjusting, by the first network node, implementation of the one or more scheduled changes such that the first network node and the second network node operate consistently with respect to the status of the communication link.

2. The method of claim 1, wherein adjusting implementation of the one or more scheduled changes comprises ignoring one of the one or more scheduled changes.

3. The method of claim 1, wherein adjusting implementation of the one or more scheduled changes comprises adjusting timing of one of the one or more scheduled changes to match with a corresponding timing of the one of the one or more scheduled changes as to be implemented by the second network node.

4. The method of claim 3, wherein the one or more scheduled changes include a first change at a first time and a second change at a second time, the first time and the second time defining endpoints of a first time interval, the method further comprising:
adjusting the first time, the second time, or both, such that the adjusted first time is a beginning of a new time interval, and the adjusted second time is an end of the new time interval,
wherein the new time interval is a union of the first time interval and a second time interval, and
wherein the one or more scheduled changes as to be implemented by the second network node include the first change at a third time and the second change at a fourth time, the third time and the fourth time defining endpoints of the second time interval.

5. The method of claim 3, wherein the one or more scheduled changes include a first change at a first time and a second change at a second time, the first time and the second time defining endpoints of a first time interval, the method further comprising:
adjusting the first time, the second time, or both, such that the adjusted first time is a beginning of a new time interval, and the adjusted second time is an end of the new time interval,
wherein the new time interval is an intersection of the first time interval and a second time interval, and
wherein the one or more scheduled changes as to be implemented by the second network node include the first change at a third time and the second change at a fourth time, the third time and the fourth time defining endpoints of the second time interval.

6. The method of claim 3, wherein the second network node also adjusts timing of the one of the scheduled changes as to be implemented by the second network node, or timing of another of the scheduled changes as to be implemented by the second network node, or both, the timing of the one or more scheduled changes matching with the timing of the one or more scheduled changes as to be implemented by the second network node following combined adjusting by the first network node and the second network node.

7. The method of claim 1, wherein adjusting the one or more scheduled changes comprises scheduling the additional change at the first network node.

8. The method of claim 1, wherein the first network node is configured with one or more rules specifying how to adjust implementation of the one or more scheduled changes.

9. The method of claim 1, wherein communicating with the second network node comprises at least one of:
sending a HELLO message indicative of the one or more scheduled changes; or
receiving another HELLO message indicative of corresponding scheduled changes as registered at the second network node.

10. The method of claim 9, wherein communicating with the second network node comprises directly communicating with the second network node.

11. A method, comprising:
receiving, by a first network node in association with a time variant routing scheme, information indicative of one or more scheduled changes in status of a communication link coupling the first network node to a second network node, the one or more scheduled changes being registered at the first network node;
communicating, by the first network node, with the second network node to obtain information indicative of whether the one or more scheduled changes are registered at the second network node in an inconsistent manner, wherein the inconsistent manner comprises at least one of: the second network node having registered at least one of the one or more scheduled changes with a different configuration than at the first network node, the second network node having not registered at least one of the one or more scheduled changes, or the second network node having registered an additional change which is not registered at the first network node; and
when the one or more scheduled changes are registered at the second network node in the inconsistent manner, adjusting, by the first network node, implementation of the one or more scheduled changes such that the first network node and the second network node operate consistently with respect to the status of the communication link.

12. The method of claim 11, wherein the different configuration includes that said at least one of the one or more scheduled changes, as registered at the second network node, assigns a cost to the communication link, the cost being different from a corresponding cost assigned to the communication link at the first network node.

13. The method of claim 11, wherein the different configuration includes that said at least one of the one or more scheduled changes, as registered at the second network node, assigns a link attribute to the communication link, the link attribute being different from a corresponding link attribute assigned to the communication link at the first network node.

14. The method of claim 13, wherein the link attribute is at least one of link color, link bandwidth, or link delay.

15. The method of claim 11, wherein the different configuration includes that said at least one of the one or more scheduled changes, as registered at the second network node, assigns a traffic volume value to the communication link, the traffic volume value being different from a corresponding traffic volume value assigned to the communication link at the first network node.

16. An apparatus comprising at least one processor coupled with at least one memory storing instructions, wherein the instructions, when executed by the at least one processor, cause the apparatus to perform operations comprising:
receiving, in association with a time variant routing scheme, information indicative of one or more scheduled changes in status of a communication link coupling the apparatus to a network node, the one or more scheduled changes being registered at the apparatus;
communicating with the network node to obtain information indicative of whether the one or more scheduled changes are registered at the network node in an inconsistent manner, wherein the inconsistent manner comprises at least one of: the network node having registered at least one of the one or more scheduled changes to occur at a different time than a corresponding one of the one or more scheduled changes is registered to occur at the apparatus, the network node having not registered at least one of the one or more scheduled changes, or the network node having registered an additional change which is not registered at the apparatus;
when the one or more scheduled changes are registered at the network node in the inconsistent manner, adjusting implementation of the one or more scheduled changes such that the apparatus and the network node operate consistently with respect to the status of the communication link.

17. The apparatus of claim 16, wherein adjusting implementation of the one or more scheduled changes comprises ignoring one of the one or more scheduled changes.

18. The apparatus of claim 16, wherein adjusting implementation of the one or more scheduled changes comprises adjusting timing of one of the one or more scheduled changes to match with a corresponding timing of the one of the one or more scheduled changes as to be implemented by the network node.

19. The apparatus of claim 18, wherein the one or more scheduled changes include a first change at a first time and a second change at a second time, the first time and the second time defining endpoints of a first time interval, the operations further comprising:
adjusting the first time, the second time, or both, such that the adjusted first time is a beginning of a new time interval, and the adjusted second time is an end of the new time interval,
wherein the new time interval is a union of the first time interval and a second time interval, and
wherein the one or more scheduled changes as to be implemented by the network node include the first change at a third time and the second change at a fourth time, the third time and the fourth time defining endpoints of the second time interval.

20. The apparatus of claim 18, wherein the one or more scheduled changes includes a first change at a first time and a second change at a second time, the first time and the second time defining endpoints of a first time interval, the apparatus further configured to:
adjusting the first time, the second time, or both, such that the adjusted first time is a beginning of a new time interval, and the adjusted second time is an end of the new time interval,
wherein the new time interval is an intersection of the first time interval and a second time interval, and
wherein the one or more scheduled changes as to be implemented by the network node include the first change at a third time and the second change at a fourth time, the third time and the fourth time defining endpoints of the second time interval.
